(19) United States
(12) Patent Application Publication
(10) Pub. No.: US 2012/0293994 A1
(43) Pub. Date: Nov. 22, 2012

(54) LED Lighting Fixture

(75) Inventor: Sean D. McMurray, Berkeley, CA (US)

(73) Assignee: ALVA LIGHT, Berkeley, CA (US)

(21) Appl. No.: 13/108,694

(22) Filed: May 16, 2011

(51) Int. Cl. F21V 21/00; F21V 1/00

(52) U.S. Cl. 362/235; 362/249.02

(57) ABSTRACT

A lighting fixture includes a support structure and at least three circuit boards that are mounted to the support structure. Each circuit board has (i) a mounting surface mounted to the support structure and (ii) an outside surface defining a plane, wherein the circuit boards are mounted so that the plane of any given one of the outside surfaces forms an obtuse angle with the plane of the outside surface of any adjacent circuit board. The fixture also includes a linear array of at least three LEDs mounted on the outside surface of each one of the circuit boards; each linear array defining a longitudinal axis and wherein the circuit boards are mounted on the support structure so that all of the longitudinal axes are parallel to one another. Such LEDs within a given array are coupled to one another using conductors of the board on which they are mounted. The fixture further includes a power connector coupled to each of the circuit boards.

### TECHNICAL FIELD

The present invention relates to lighting fixtures, and more particularly to lighting fixtures employing light-emitting diodes (LEDs).

### BACKGROUND ART

It is known in the prior art to provide planar arrays of LEDs mounted on a flat surface, which may serve as a heat sink, on which also is mounted a semiconductor power driving system for the LEDs. Such a device, for example, is available from Osram. Osram's DL1100 Directional Light Engine includes 24 high-brightness LEDs on a metal core board (MCB). This LED light engine is typical of LED solutions targeting the light fixture retrofit market. It is designed to be mounted inside the fixture in replace of either an incandescent or Compact Florescent.

### SUMMARY OF THE EMBODIMENTS

In a first embodiment of the invention there is provided a lighting fixture comprising a support structure and at least three circuit boards that are mounted to the support structure. Each circuit board has (i) a mounting surface mounted to the support structure and (ii) an outside surface defining a plane, wherein the circuit boards are mounted so that the plane of any given one of the outside surfaces forms an obtuse angle with the plane of the outside surface of any adjacent circuit board. The fixture also includes a linear array of at least three LEDs mounted on the outside surface of each one of the circuit boards; each linear array defining a longitudinal axis and wherein the circuit boards are mounted on the support structure so that all of the longitudinal axes are parallel to one another. Such LEDs within a given array are coupled to one another using conductors of the board on which they are mounted. The fixture further includes a power connector coupled to each of the circuit boards.

In a related embodiment, the support structure is configured as a heat sink. Optionally, the support structure is aluminum. Alternatively or in addition, the fixture further includes a light-transmitting cover mounted to the support and disposed over the circuit boards so as to diffuse light from the LEDs. Optionally, the cover includes cloth for diffusing the light.

In a further related embodiment each LED on any given one of the boards (i) has a similar beam angle in a plane perpendicular to the longitudinal axis passing therethrough and (ii) has a corresponding LED, on an adjacent one of the boards, lying in the recited perpendicular plane. In this embodiment, the obtuse angle is selected so that (a) the beam from each LED on the given one of the boards partially overlaps the beam from the corresponding LED on the adjacent one of the boards, and (b) illumination from the fixture is free of gaps between adjacent beams in the recited perpendicular plane.

Alternatively or in addition, the support structure contains a series of slots, and each slot corresponds to, and receives, one of the circuit boards, wherein the series of slots generally defines orientation of the circuit boards relative to one another. Optionally, each slot includes a pair of opposed channels for receiving a transparent protective cover that is slidably insertable over a circuit board that has been placed in the slot.

In a further related embodiment, the support structure is extruded and may optionally be constructed of aluminum.

### BRIEF DESCRIPTION OF THE DRAWINGS

The foregoing features of embodiments will be more readily understood by reference to the following detailed description, taken with reference to the accompanying drawings, in which:

FIG. 1 is diagrammatic view of an embodiment of the present invention illustrating relative angles of circuit boards mounting LEDs in a fixture;

FIG. 2 is a horizontal section of a combination heat sink and support structure in accordance with an embodiment of the present invention;

FIGS. 3 and 4 are perspective views of the rear and front respectively of the heat sink support structure of FIG. 2;

FIG. 5 is an exploded view of a fixture in accordance with a related embodiment showing the combination heat sink and support structure as well as circuit boards that mount a linear array of LEDs;

FIG. 6 is a further exploded view of the embodiment of FIG. 5, showing additional components of the fixture;

FIG. 7 is a front view of the fixture of FIG. 6;

FIG. 8 is a horizontal section of the fixture of FIG. 6;

FIG. 9 is a side view of the fixture of FIG. 6;

FIG. 10 is a perspective view of the fixture of FIG. 6, showing use with a shade exploded off of the rest of the fixture;

FIG. 11 is an exploded view of another embodiment in accordance with the present invention, analogous to the view in FIG. 6, but wherein there are employed 4 linear arrays of LEDs;

FIG. 12 is a front view of the fixture of FIG. 11 showing a corresponding sectional view of the combination heat sink and support structure;

FIG. 13 is a perspective view of the fixture of FIG. 11 shown with a shade; and

FIG. 14 is another view of the fixture of FIG. 11, wherein the shade is rendered in a semitransparent manner.

### DETAILED DESCRIPTION OF SPECIFIC EMBODIMENTS

Definitions. As used in this description and the accompanying claims, the following terms shall have the meanings indicated, unless the context otherwise requires:

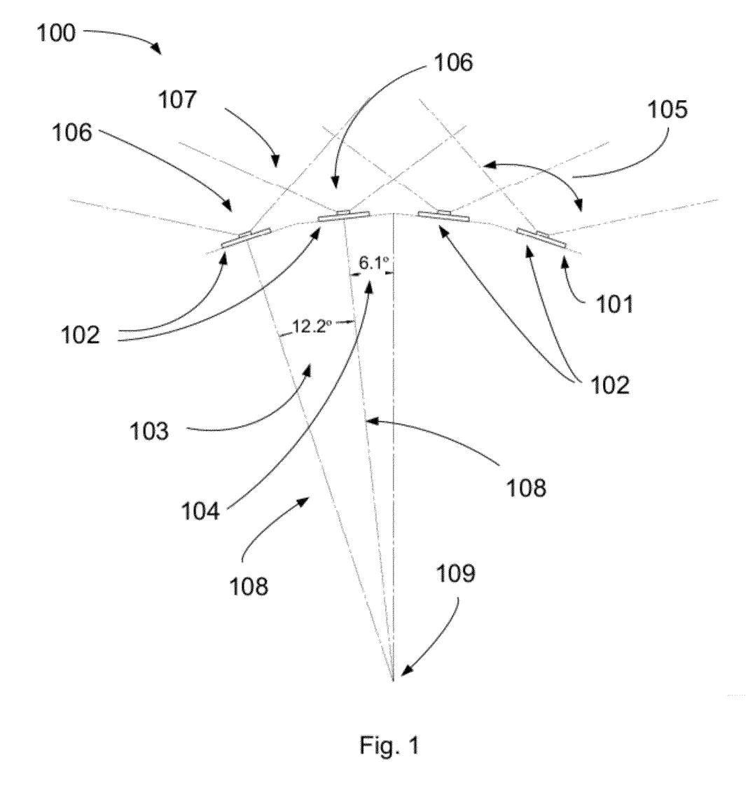

The “beam angle” of an LED light is the angle spanned by an arc that crosses the light beam radiating from the LED along a beam axis, and may be measured in degrees. For example, if the intensity of light radiating from an LED is maximum along a line (the “beam axis”) that includes the LED, then the beam angle of the light from that LED may be defined as the angle between points on opposite sides of the beam axis where the intensity drops to 50% of maximum (see, for example, angle 105 in FIG. 1). The volume within the beam angle may present a cone of light from the LED.

A “heat sink” is a structure capable of transferring heat energy way from an LED by conduction or convection. Some heat sinks transfer heat energy to a fluid medium such as air, and some such heat sinks have fins or other physical features to facilitate transfer of the heat energy from the heat sink to the fluid medium. A heat sink may comprise aluminum, copper, or other thermally-conductive material.

A “thermal via” is thermally conductive material thermally coupled between a heat source and a heat sink, so as to conduct heat from the heat source to the heat sink.

A “power connector” coupled to each of a plurality of circuit boards may be implemented as wiring from a power supply to each one of the circuit boards or, alternatively, the wiring may go to a selected one of the circuit boards, and other circuit boards may receive power from the selected one of the circuit boards or from another one of the circuit boards which has received power indirectly from the power supply. In some further embodiments, a plurality of boards may be powered directly and another plurality may be powered indirectly by one or more power supplies. In each case, the circuit board has received power from a “power connector” as herein defined.

FIG. 1 is diagrammatic view of an embodiment illustrating relative angles of printed circuit boards (PCBs) mounting LEDs 106 in a fixture. Each PCB 102 has a mounting surface (each identified generally by a corresponding arrow 102) defining a plane. It can be seen from FIG. 1 that these planes are at angles with respect to one another. The angles can be measured as the angular distance 103 between adjacent perpendiculars 108 to adjacent mounting surfaces. The adjacent perpendiculars 108 intersect at a common point 109. In some embodiments, three or more LEDs may share a common center point 109, while in some embodiments sub-groups of LEDs may define a plurality of center points.

The exact angular distance 103 to be chosen may usefully be determined by reference to the beam angle 105 from each of the LEDs. For example, when the beam angle 105 is about 120 degrees, and the angular distance 103 may be usefully set at approximately 12.2 degrees, so that light beams from the LEDs overlap one another without gaps while still providing light that covers a relatively wide angular area, and a significantly wider one than if all of the circuit boards were mounted in the same plane. In the embodiment of FIG. 1, a second angle 104 defines the angular distance between one of the perpendiculars and the point of intersection of two adjacent planes.

The angular distance 103 may also usefully be determined by the point 107 at which light cones from adjacent LEDs intersect. In the embodiment of FIG. 1, the intersection point 107 is close to the LEDs 106. For example, if the distance between one LED and its immediate neighbor is 5 centimeters, then the intersection point 107 in FIG. 1 is slightly less than 5 centimeters. However, the intersection point could be moved closer to or further from the LEDs by varying the angular distance 103, or by using LEDs with beam angles that are wider or narrower than those shown in FIG. 1. Such adaptations may be desirable and useful depending, for example, on the distance from the fixture of the location to be illuminated.

Further, some embodiments may include LEDs with non-uniform beam angles. For example, the LEDs on two PCBs may have a beam angle of 120 degrees, while the LEDs on another PCB may have a beam angle of 100 degrees. The angular distance between PCBs may therefore be non-uniform in order to avoid gaps in illumination.

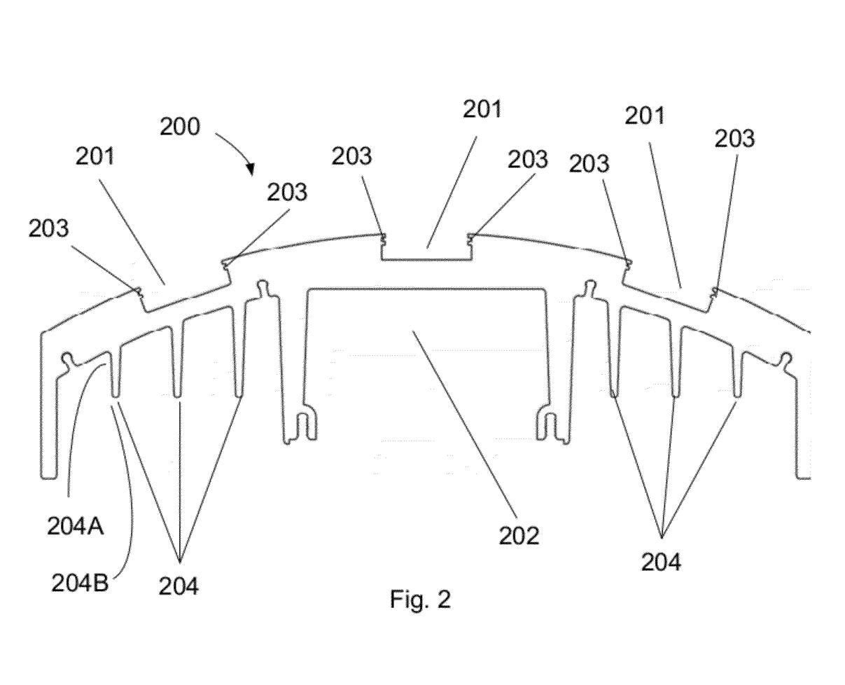

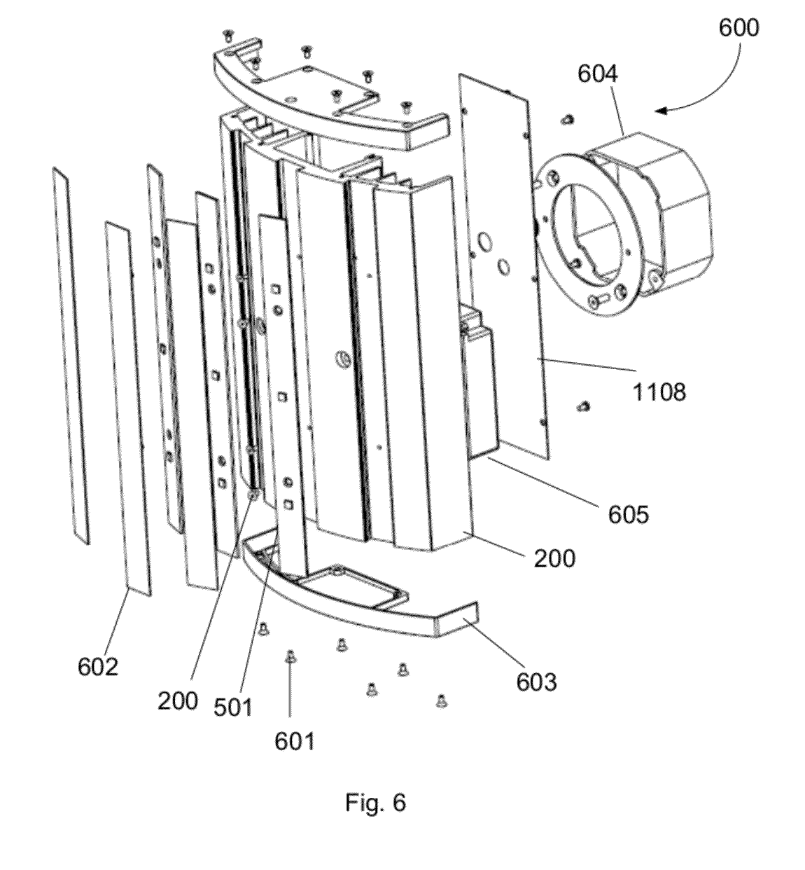

FIG. 2 is a horizontal section of a combination heat sink and support structure 200 in accordance with an embodiment of the present invention. The heat sink and support structure 200 includes a plurality of channels 201, each for receiving a PCB. Each channel may include grooves 203 that are extruded and allow for the insertion of an optical lens (see FIG. 6, optical lens 602). The optical lens may be made of, without limitation, optical grade polycarbonate or PETG. The placement of the lens provides for even diffusion of the lumens generated by the LEDs. Furthermore, the lens may offer protection for the LEDs. The back cavity 202 illustrated may house various electronic components. In alternate embodiments, the PCBs may be mounted directly on the surface of a fixture, for example if the mounting surface is multi-faceted such that each PCB mounts flat to a corresponding facet (see, for example, a surface represented by line 101 in FIG. 1). Such mounting may facilitate conduction of heat from the LEDs and/or PCBs to the fixture and may even include a conductive paste or one or more thermal vias at the interface of the PCB and facet.

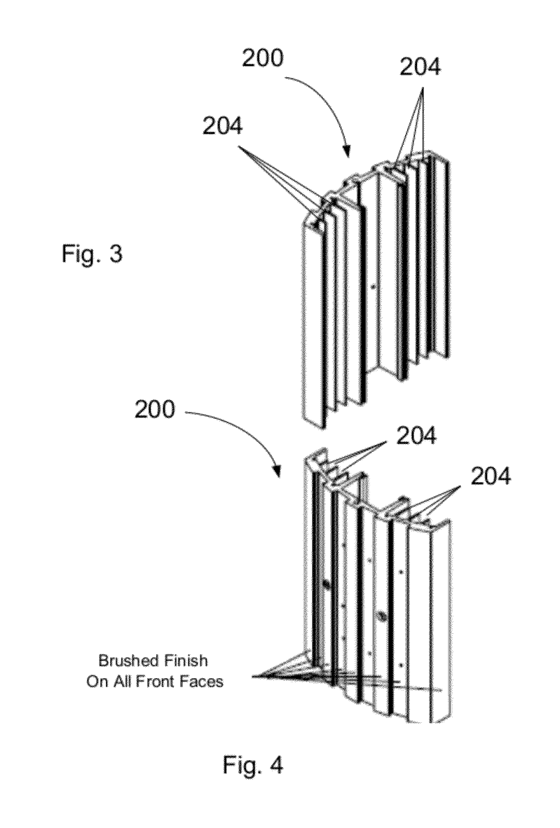

FIGS. 3 and 4 are perspective views of the rear and front respectively of the heat sink support structure 200 of FIG. 2. The heat sink support structure may include one or more fins 204. The fins 204 may be extruded in a fashion to facilitate or maximize the dissipation of the heat generated by the LEDs. In FIG. 2, the long axis of each fin 204 is substantially parallel to the long axis of each other fin, and the fins 204 are therefore not normal to the curved face of the support structure 200. In alternate embodiment, the long axis of a fin 204 may be at an angle to another fin 204, such as an adjacent fin 204, for example. Indeed, in some embodiments, the long axis of a fin 204 may be normal to the curved surface of the support structure, with the result that each fin will be at an angle with respect to its neighbor (in other words, the base 204A and ridge 204B of one fin 204 would not be equidistant from, respectively, the base and ridge of an adjacent fin 204).

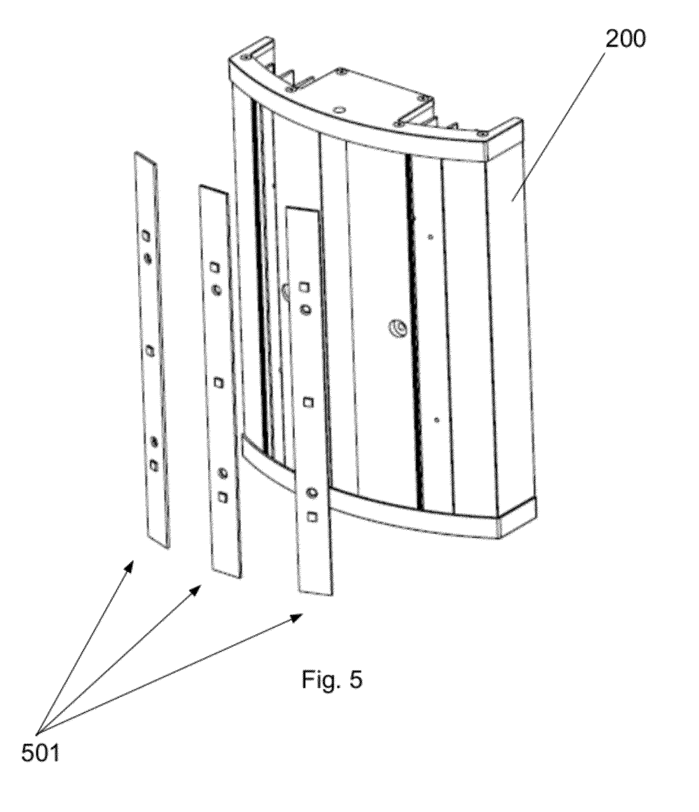

FIG. 5 is an exploded view of a fixture in accordance with a related embodiment showing the combination heat sink and support structure 200 as well as PCBs 501 that mount a linear array of LEDs. The PCBs 501 may be made, in part, from a metal core or FR4 (glass reinforced epoxy laminate), and in some embodiments may include thermal vias. In other embodiments, one or more of the PCBs 501 may have as few as a single LED. In such an embodiment, the fixture would still illuminate an arc of space, since a plurality of PCBs will each have an angular distance between them. Although the LEDs on a PCB in illustrative embodiments are presented as defining a linear array, some deviation in the alignment of the LEDs may be permissible, and still yield substantially gapless illumination.

FIG. 6 is a further exploded view of the embodiment of FIG. 5, showing additional components of the fixture 600. The PCBs 501 may be mounted onto the heat sink support structure 200 via, without limitation, a combination of screws 601 and thermal grease. In other embodiments, the PCBs 501 may be mounted using, at least in part, thermal tape or a combination of thermal tape and screws. In yet other embodiments, the PCBs 501 may be mounted using, at least in part, one or more clamping mechanisms. Illustratively, the PCBs 501 mounted within the channels of the support structure 200 are angled with respect to each other so as to advantageously provide a desired LED overlap while covering a wide angular area, as described above.

The optical lenses 602 are inserted into the grooves noted with regard to FIG. 2. The lenses may be held in place by end caps 603 located on both ends of the heat sink support system 200. The back cavity noted in FIG. 2 may be covered with a back cover 1108. The back cavity may, without limitation, hold an electronic power system 605 for providing power to the PCBs 501. For example, the power system 605 may include a power transformer, a constant current source, a current mirror, a constant voltage source, ballast resistors, etc., as desired to provide the power for a given embodiment. Such elements may connect to the LEDs, the PCBs 501, and the junction box 604. The heat sink support system 200 may optionally mount directly onto a junction box 604.

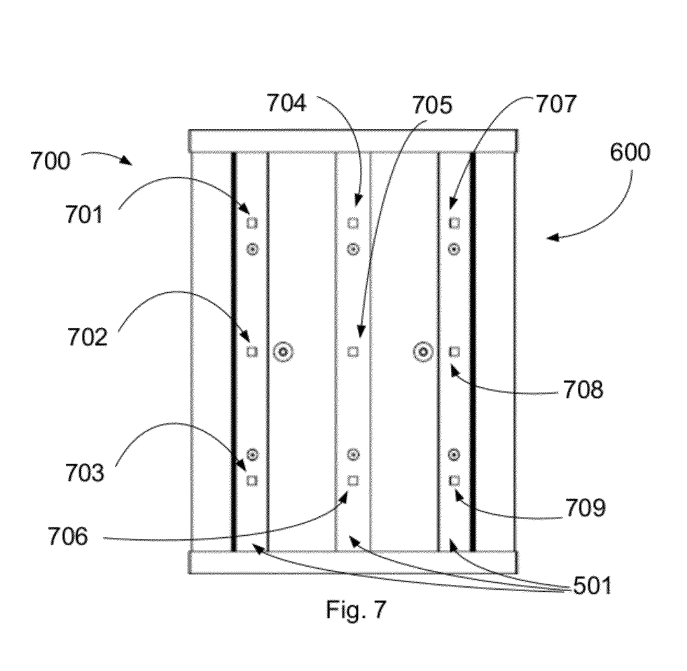

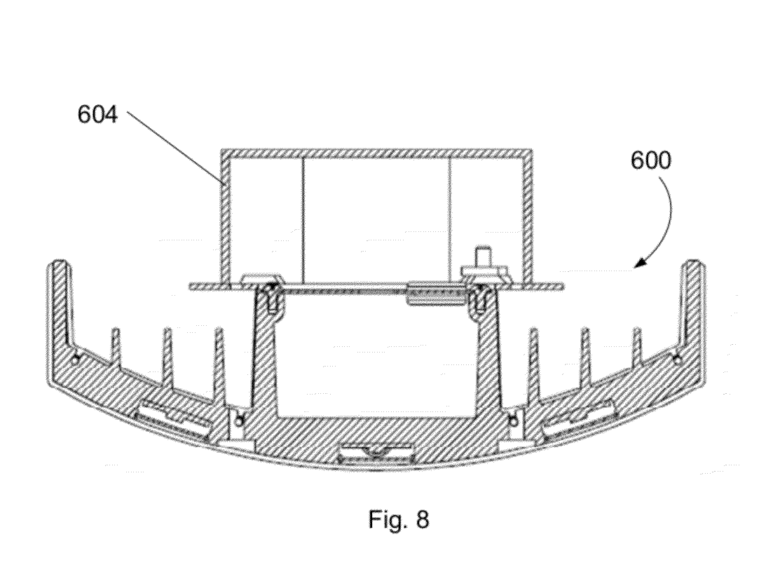

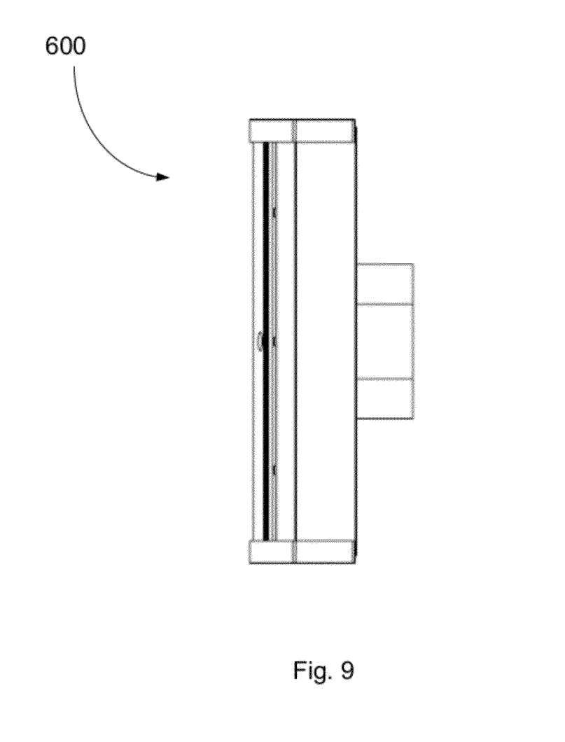

FIGS. 7-9 show various views of the fixture 600 of FIG. 6. More particularly, FIG. 7 is a front view of the fixture 600 of FIG. 6, FIG. 8 is a horizontal section of the fixture 600 of FIG. 6, while FIG. 9 shows a side view of the fixture 600 of FIG. 6. The embodiment of FIG. 7 schematically illustrates three PCBs 501, each bearing three LEDs, for a total of nine LEDs (701-709). As can be seen in FIG. 7, the nine LEDs form a matrix 700 in which each LED forms a substantially linear array not only with the other LEDs on its PCB 501, but also with LEDs on the other PCBs. For example, the LED 701 in the upper-left corner of FIG. 7 forms a linear array with the LEDs 704, 707 extending to the right and another linear array diagonally through the center LED 705 and the LED 709 at the lower-right corner. Such an array, which in the plan view of FIG. 7 is schematically illustrated as a two-dimensional array, may facilitate uniform light distribution. In such an array, each LED may be a member of at least two or three substantially linear arrays.

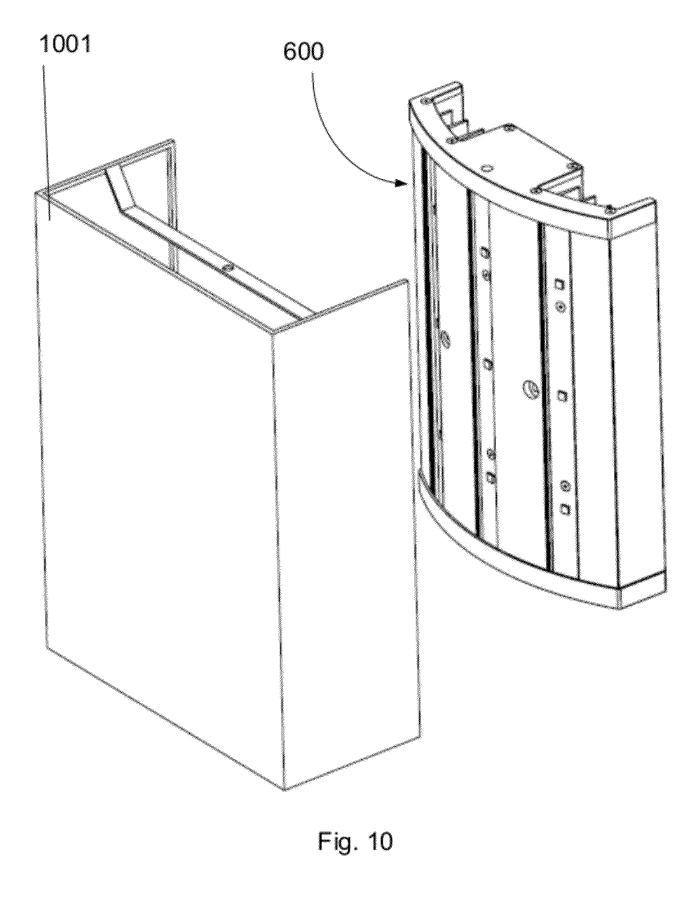

FIG. 10 is a perspective view of the fixture 600 of FIG. 6, showing use with a shade 1001 exploded off of the rest of the fixture 600. A wide variety of shades can be mounted to the heat sink support structure in creating the light fixture. For example, the shade 1001 may be of various material, shape and size, and provide various levels of diffusion and/or transparency depending on application. A shade may be translucent or transparent. In some embodiments, a shade may include a cloth for diffusing the light. In some embodiments, the shade may be opaque, and/or may have a reflective surface facing the LED to divert impinging light to create a halo effect around the fixture, for example to produce indirect or back-lighting.

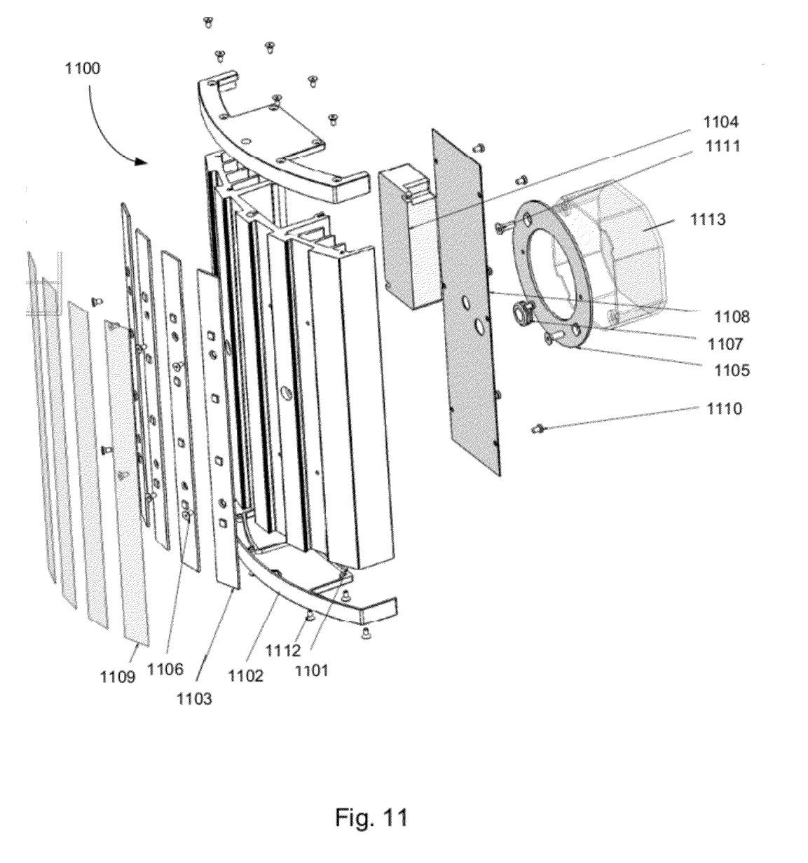

FIG. 11 is an exploded view of another embodiment in accordance with the present invention, analogous to the view in FIG. 6, but wherein there are employed 4 linear arrays of LEDs. More particularly, heat sink support structure 1101 includes four channels into each of which a PCB 1103 is inserted via screws 1106. It is to be understood that the light fixture may include any number of channels/LEDs arrays. As in above embodiments, a lens 1109 may be inserted above each PCB 1103 via, without limitation, grooves within each channel. Endcaps 1102 may be used to hold the lenses in place, the endcaps 1102 mounted to the heat sink support structure 1101 via, for example screws 1112. An electronic power system 1104 and/or other electronic components may reside within the back cavity of the heat sink support system 1101, which may be closed off with back cover 1108 via mounting hardware 1110. A junction box 1113 may attach to the heat sink support structure 1101 via gasket and mounting hardware 1107, 1111 and 1105.

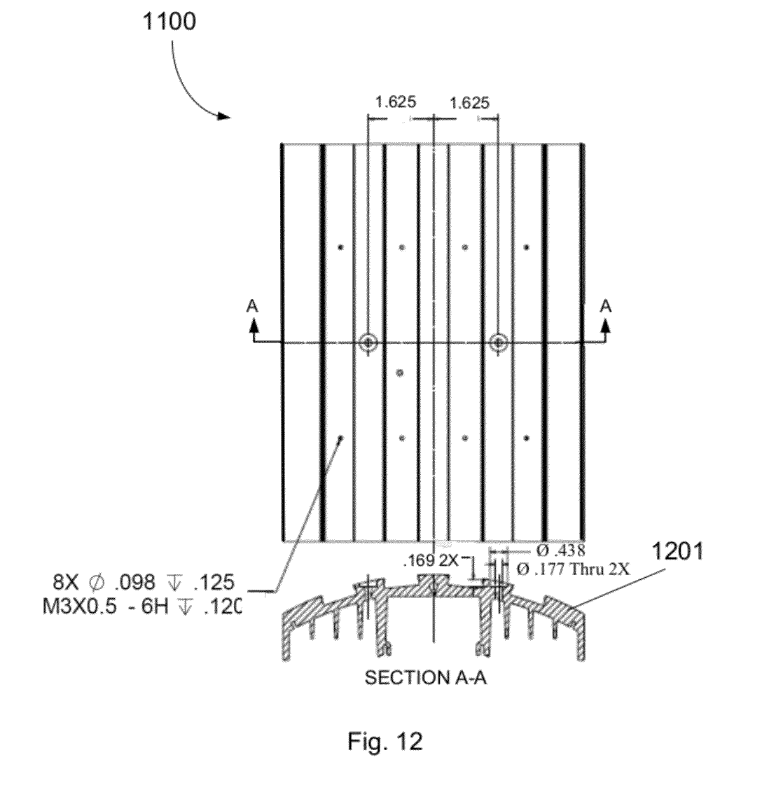

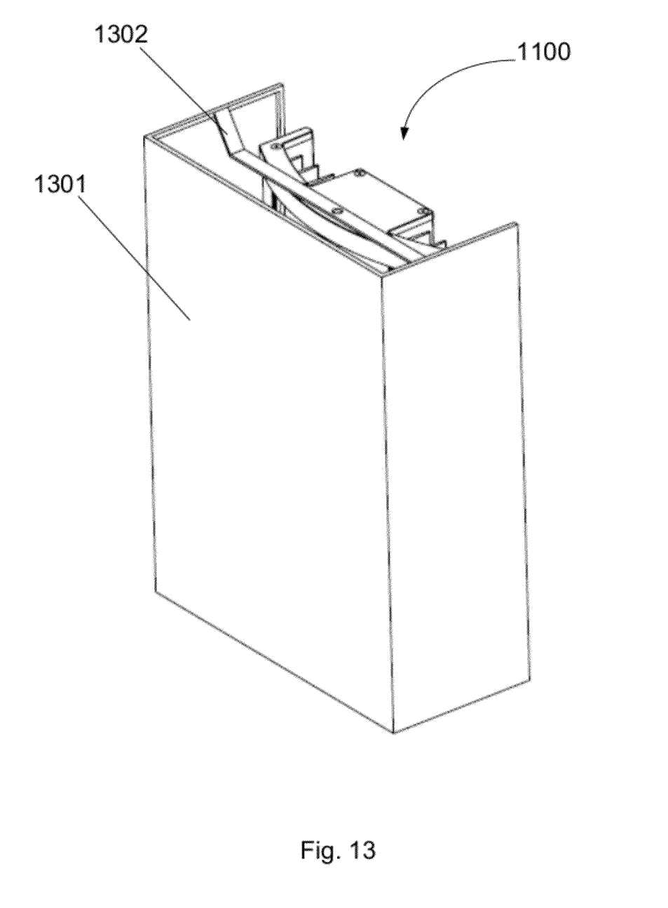

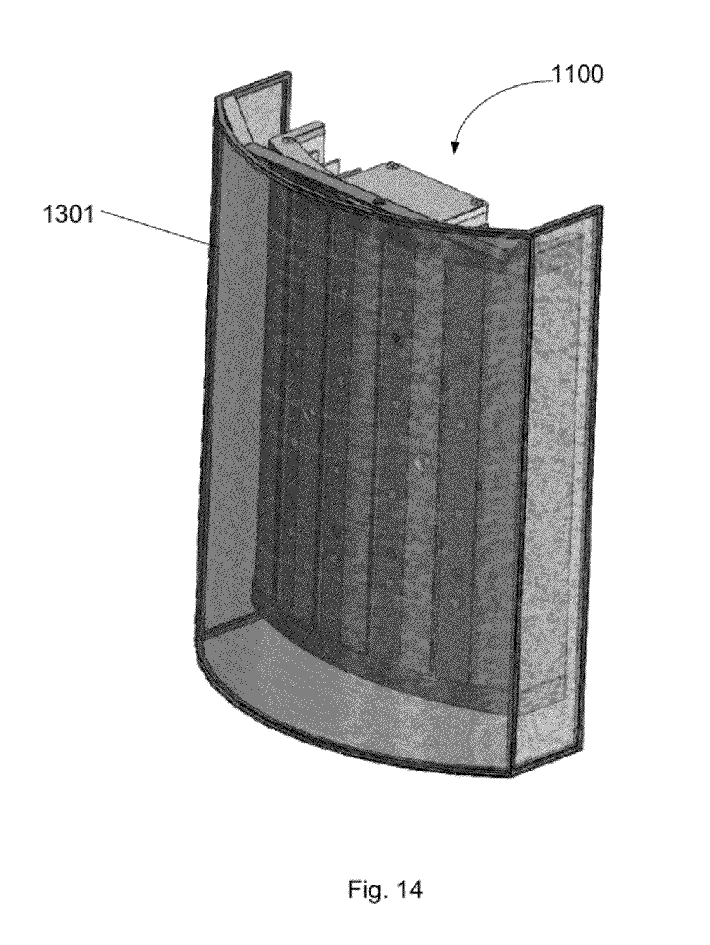

FIG. 12 is a front view of the fixture 1100 of FIG. 11 showing a corresponding sectional view 1201 of the combination heat sink and support structure 1101. FIG. 13 is a perspective view of the fixture 1100 of FIG. 11 shown with a shade 1301. The shade 1301 may mounts, without limitation, via a cross bar 1302 on the shade 1301 to the top of the heat sink structure 1101. FIG. 14 is another view of the fixture of FIG. 11, wherein the shade is rendered in a semitransparent manner. In some embodiments, the shade 11 may have a curbed face (i.e., may have a curved cross-section).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A lighting fixture comprising:
a support structure;
at least three circuit boards, each circuit board having (i) a mounting surface mounted to the support structure and (ii) an outside surface defining a plane, wherein the circuit boards are mounted so that the plane of any given one of the outside surfaces forms an obtuse angle with the plane of the outside surface of any adjacent circuit board;
a linear array of at least three LEDs mounted on the outside surface of each one of the circuit boards; each linear array defining a longitudinal axis and wherein the circuit boards are mounted on the support structure so that all of the longitudinal axes are parallel to one another;
such LEDs within a given array being coupled to one another using conductors of the board on which they are mounted; and
a power connector coupled to each of the circuit boards.

2. A fixture according to claim 1, wherein the support structure is configured as a heat sink.

3. A fixture according to claim 2, wherein the support structure is aluminum.

4. A fixture according to claim 1, further comprising:
a light-transmitting shade mounted to the support and disposed over the circuit boards so as to diffuse light from the LEDs.

5. A fixture according to claim 4, wherein the shade includes cloth for diffusing the light.

6. A fixture according to claim 1, wherein each LED on any given one of the boards (i) has a similar beam angle in a plane perpendicular to the longitudinal axis passing therethrough and (ii) has a corresponding LED, on an adjacent one of the boards, lying in the recited perpendicular plane, and wherein the obtuse angle is selected so that (a) the beam from each LED on the given one of the boards partially overlaps the beam from the corresponding LED on the adjacent one of the boards, and (b) illumination from the fixture is free of gaps between adjacent beams in the recited perpendicular plane while still achieving angular coverage that is wider that would be obtained when the obtuse angle is 180 degrees.

7. A fixture according to claim 2, wherein the support structure contains a series of slots, each slot corresponding to, and receiving, one of the circuit boards, wherein the series of slots generally defines orientation of the circuit boards relative to one another.

8. A fixture according to claim 7, wherein each slot includes a pair of opposed channels for receiving a transparent protective cover that is slidably insertable over a circuit board that has been placed in the slot.

9. A fixture according to claim 7, wherein the support structure is extruded.

10. A fixture according to claim 9, wherein support structure is aluminum.
